(19) United States
(12) Patent Application Publication
(10) Pub. No.: US 2004/0117752 A1
(43) Pub. Date: Jun. 17, 2004

(54) Method and apparatus for routing integrated circuit traces to reduce inductive noise coupling

(76) Inventors: Ghun Kim, Sunnyvale, CA (US); Seong Rai Cho, San Jose, CA (US); Jiun-Cheng Hsu, Sunnyvale, CA (US); Yet-Ping Pai, Milpitas, CA (US)

Correspondence Address: PARK, VAUGHAN & FLEMING LLP, 508 SECOND STREET, SUITE 201, DAVIS, CA, 95616, US

(21) Appl. No.: 10/317,483

(22) Filed: Dec. 12, 2002

(51) Int. Cl. G06F 17/50

(52) U.S. Cl. 716/12

(57) ABSTRACT

One embodiment of the present invention provides a system that facilitates routing integrated circuit traces to reduce inductive noise coupling. Upon receiving an integrated circuit layout, the system routes traces between circuit elements of the integrated circuit through multiple layers of the integrated circuit layout. In doing so, the system groups traces together within each layer and separates each group from adjacent groups in the same layer using a shield trace. The system also routes a nearby shield trace on a nearby layer so that the nearby shield trace runs parallel to and is substantially centered on a group of traces within the layer. In this way, the nearby shield trace also provides inductive shielding for the group of traces.

### BACKGROUND

1. Field of the Invention

The present invention relates to the process of routing traces between circuit elements within integrated circuits. More specifically, the present invention relates to a method and an apparatus for routing traces between circuit elements in a manner that reduces inductive noise coupling between the traces.

2. Related Art

As processor clock speeds continue to increase at an exponential rate, it is becoming increasingly harder to route signal lines between circuit elements in a manner that meets timing requirements. For this reason, it is becoming increasingly important to minimize the amount of propagation delay through nets that are used to carry the signals between circuit elements. At lower clock frequencies, resistance and capacitance are the dominant factors in determining propagation delay through these nets. However, as clock frequencies continue to increase, inductance—both self-inductance and mutual inductance with neighboring nets—is becoming an increasingly more significant factor in determining propagation delay. Failing to account for inductive effects in a high-speed integrated circuit can lead to non-optimal routing, invalid timing margins, and poor performance.

At present, circuit designers do little to reduce effects of inductive noise. Modern integrated circuits typically include eight or more metal layers for connecting circuit elements together. Within a given layer, signal lines typically run parallel to each other, whereas, signal lines in adjacent layers typically run perpendicular to each other. For example, signal lines in a first layer may run from West to East, while signal lines in an adjacent second layer may run from North to South.

Note that propagation delay can be controlled by varying the width and spacing between traces on the layers. Wider traces tend to have less resistance and therefore less propagation delay, whereas narrower traces tend to have more resistance and therefore more propagation delay. For example, in a typical integrated circuit, layers one through four are the most densely packed, and thus provide the greatest delay per unit length. Layers five and six provide are less densely packed, and consequently provide an intermediate delay per unit length. Finally, layers seven and eight are the least densely packed and therefore provide the lowest delay per unit length.

Within these integrated circuits, parallel power and ground traces are typically interleaved with signal line traces on the same layer. These power and ground traces tend to reduce inductive noise between signal lines, but their effectiveness in this regard is somewhat limited because these power and ground traces reside in the same layer as the signal lines. Hence, they cannot provide inductive shielding above and below the signal lines.

What is needed is a method and an apparatus for routing traces between circuit elements in a manner that reduces the effects of inductive noise.

### SUMMARY

One embodiment of the present invention provides a system that facilitates routing integrated circuit traces to reduce inductive noise coupling. Upon receiving an integrated circuit layout, the system routes traces between circuit elements of the integrated circuit through multiple layers of the integrated circuit layout. In doing so, the system groups traces together within each layer and separates each group from adjacent groups in the same layer using a shield trace. The system also routes a nearby shield trace on a nearby layer so that the nearby shield trace runs parallel to and is substantially centered on a group of traces within the layer. In this way, the nearby shield trace also provides inductive shielding for the group of traces.

In a variation of this embodiment, each layer can provide a different trace spacing and a different trace width from neighboring layers to provide a different propagation delay.

In a further variation, traces within the layer are oriented perpendicular to traces in adjacent layers.

In a further variation, grouping traces together within each layer involves establishing a grouping pattern for each layer that allows alternate layers to be aligned so that the shield trace on the nearby layer is substantially centered on the group of traces within the layer.

In a further variation, the shield trace can be a power trace or a ground trace.

### BRIEF DESCRIPTION OF THE FIGURES

FIG. 1 illustrates routing software in accordance with an embodiment of the present invention.

FIG. 2 illustrates signal traces and shield traces in accordance with an embodiment of the present invention.

FIG. 3 illustrates patterns for trace groups in accordance with an embodiment of the present invention.

FIG. 4 is a flowchart illustrating the process of routing traces in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Routing Software

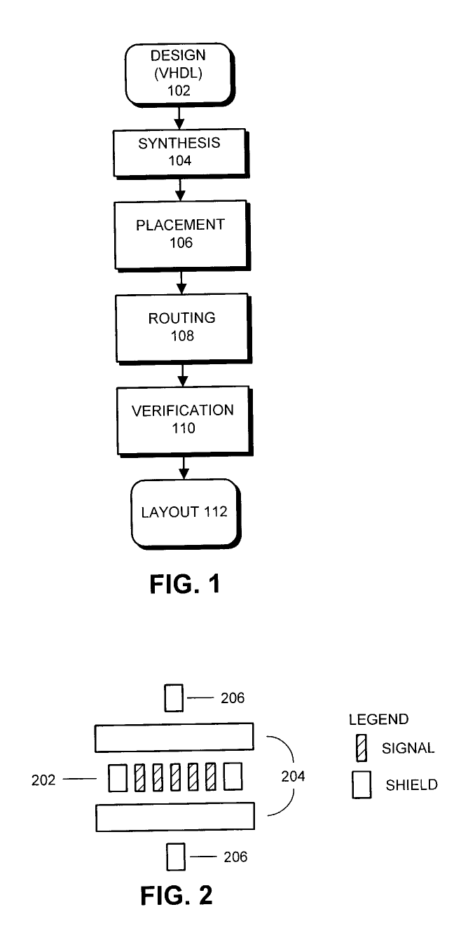

FIG. 1 illustrates the software involved in the circuit design process in accordance with an embodiment of the present invention. This software can generally execute on any type of computer system, including, but not limited to, a computer system based on a microprocessor, a mainframe computer, a digital signal processor, a portable computing device, a personal organizer, a device controller, and a computational engine within an appliance. This software operates on a design 102 to produce a layout 112. In doing so, the software makes use of various modules, including synthesis module 104, placement module 106, routing module 108 and verification module 110.

The circuit design process starts when a circuit designer produces a design 102 in VHDL, or some other hardware description language. VHDL is an acronym for VHSIC Hardware Description Language. (VHSIC is a Department of Defense acronym that stands for very high-speed integrated circuits.) The VHDL standard has been codified in Institute for Electrical and Electronic Engineers (IEEE) standard 1076-1993.

The design first passes through synthesis module 104, which decomposes the design into circuit elements. Next, placement module 106 places the various circuit elements onto an integrated circuit floor plan. Next, routing module 108 routes the various traces, which interconnect the circuit elements together.

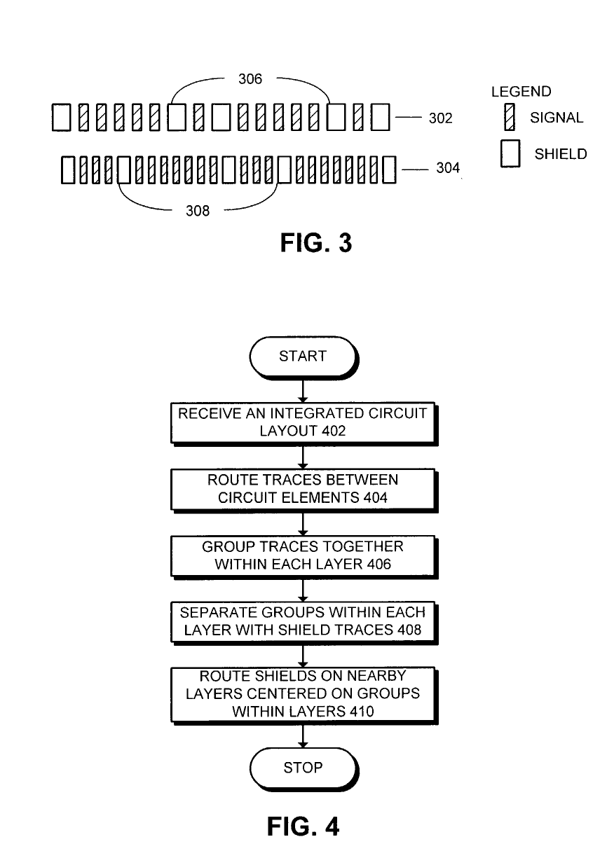

During the routing process, routing module 108 groups the traces together using specific patterns that are described below in conjunction with FIGS. 2 and 3. Routing module 108 also places shield traces between the groups of traces to reduce inductive coupling between the traces. Note that these shield traces are typically power and ground traces. Routing module 108 also aligns shield traces in one metal layer so that they are substantially centered on a group of signal traces in a nearby layer. For example, shield traces within layer five can centered on a group of signal traces within layer seven, while shield traces within layer seven can be centered on a group of signal traces within layer five. This alignment is described in more detail in conjunction with FIGS. 2 and 3 below.

After the signal lines have been routed, the layout is verified for completeness and correctness by verification module 110. This results in a final layout 112 for the integrated circuit.

Signal Traces and Shield Traces

FIG. 2 illustrates signal traces and shield traces in accordance with an embodiment of the present invention. As illustrated in FIG. 2, traces 202 include five signal traces with a shield trace on either end of the group of five signal traces. Other traces 204 are located on adjacent layers and, as a consequence, are oriented perpendicularly to traces 202. Shield traces 206 are located two layers away from traces 202, and are substantially centered on the group of signal traces in layer 202. This positioning reduces inductive coupling between signal traces in different layers.

Trace Patterns

FIG. 3 illustrates patterns of trace groupings that facilitate inductive shielding in accordance with an embodiment of the present invention. Traces 302 and 304 are located in nearby layer and have been grouped to allow shield traces within one layer to be substantially centered on groups of signal traces on the other layer. For example, traces 302 can be located on layer seven while traces 304 can be located on layer five. Note that these layers typically have different trace densities as described above. Traces 302 might have a density of, for example, 230 tracks per millimeter (t/mm), while traces 304 might have a density of 385 t/mm. Also note that other densities can be used.

As is illustrated in FIG. 3, traces 302 are grouped in a 5-1-5-1 pattern with each group of five signals separated by a shield trace. Moreover, races 304 have been grouped in a 3-7-3-7 pattern, wherein alternating groups of three and seven traces are separated by a shield traces. Note that shield traces 306 within traces 302 are substantially centered on the groups of seven signal traces within traces 304 while shield traces 308 are substantially centered on the groups of five signal traces within traces 302. This arrangement of the shield traces relative to the signal traces on nearby layers reduces inductive coupling between the signal traces. Note that different grouping patterns can be used to allow for different trace densities and to provide different levels of attenuation of inductive effects.

Routing Traces

FIG. 4 is a flowchart illustrating the process of routing traces in accordance with an embodiment of the present invention. The system starts when a designer provides design 102 for an integrated circuit layout for performing trace routing (step 402). Next, routing module 108 routes the signal traces between the circuit elements (step 404). Note that any suitable trace routing technique can be used to route the traces.

In doing so, routing module 108 groups the traces within a layer using a specific pattern for the layer and for nearby layers (step 406). Note that the term “nearby layers” refers to the nearest layers that are oriented in the same direction as the layer under consideration. After routing module 108 has grouped the traces, routing module 108 separates the groups within each layer with shield traces (step 408). In doing so, routing module 108 ensures that shield traces on one layer are substantially centered on signal trace groups on the nearby layers (step 410).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for routing integrated circuit traces to reduce inductive noise coupling, comprising:
receiving an integrated circuit layout;
routing traces between circuit elements of the integrated circuit layout through multiple layers of the integrated circuit layout;
grouping traces together within each layer;
separating each group within a layer from adjacent groups in the layer with a shield trace; and
routing a nearby shield trace on a nearby layer so that the nearby shield trace runs parallel to and is substantially centered on a group of traces within the layer, so that the nearby shield trace provides inductive shielding for the group of traces.

2. The method of claim 1, wherein each layer can include a different trace spacing and a different trace width from neighboring layers to provide a different propagation delay for traces on each layer.

3. The method of claim 1, wherein traces within the layer are oriented perpendicular to traces in adjacent layers.

4. The method of claim 1, wherein grouping traces together within each layer involves establishing a grouping pattern for each layer that allows alternate layers to be aligned so that the shield trace on the nearby layer is substantially centered on the group of traces within the layer.

5. The method of claim 1, wherein the shield trace can be a power trace or a ground trace.

6. An apparatus for routing integrated circuit traces to reduce inductive noise coupling, comprising:
a receiving mechanism that is configured to receive an integrated circuit layout;
a routing mechanism that is configured to route traces between circuit elements of the integrated circuit layout through multiple layers of the integrated circuit layout;
a grouping mechanism that is configured to group traces together within each layer; and
a separating mechanism that is configured to separate each group within a layer from adjacent groups in the layer with a shield trace;
wherein the routing mechanism is further configured to route a nearby shield trace on a nearby layer so that the nearby shield trace runs parallel to and is substantially centered on a group of traces within the layer, so that the nearby shield trace provides inductive shielding for the group of traces.

7. The apparatus of claim 6, wherein each layer can include a different trace spacing and a different trace width from neighboring layers to provide a different propagation delay for traces on each layer.

8. The apparatus of claim 6, wherein traces within the layer are oriented perpendicular to traces in adjacent layers.

9. The apparatus of claim 6, wherein grouping traces together within each layer involves establishing a grouping pattern for each layer that allows alternate layers to be aligned so that the shield trace on the nearby layer is substantially centered on the group of traces within the layer.

10. The apparatus of claim 6, wherein the shield trace can be a power trace or a ground trace.

11. An integrated circuit formed using a routing process for routing integrated circuit traces to reduce inductive noise coupling, the routing process comprising:
receiving an integrated circuit layout;
routing traces between circuit elements of the integrated circuit layout through multiple layers of the integrated circuit layout;
grouping traces together within each layer;
separating each group within a layer from adjacent groups in the layer with a shield trace; and
routing a nearby shield trace on a nearby layer so that the nearby shield trace runs parallel to and is substantially centered on a group of traces within the layer, so that the nearby shield trace provides inductive shielding for the group of traces.

12. The integrated circuit of claim 11, wherein each layer can include a different trace spacing and a different trace width from neighboring layers to provide a different propagation delay for traces on each layer.

13. The integrated circuit of claim 11, wherein traces within the layer are oriented perpendicular to traces in adjacent layers.

14. The integrated circuit of claim 11, wherein grouping traces together within each layer involves establishing a grouping pattern for each layer that allows alternate layers to be aligned so that the shield trace on the nearby layer is substantially centered on the group of traces within the layer.

15. The integrated circuit of claim 11, wherein the shield trace can be a power trace or a ground trace.

16. A computer-readable storage medium storing a layout tool that when executed by a computer cause the computer to perform a method for routing integrated circuit traces to reduce inductive noise coupling, the method comprising:
receiving an integrated circuit layout;
routing traces between circuit elements of the integrated circuit layout through multiple layers of the integrated circuit layout;
grouping traces together within each layer;
separating each group within a layer from adjacent groups in the layer with a shield trace; and
routing a nearby shield trace on a nearby layer so that the nearby shield trace runs parallel to and is substantially centered on a group of traces within the layer, so that the nearby shield trace provides inductive shielding for the group of traces.

17. The computer-readable storage medium of claim 16, wherein each layer can include a different trace spacing and a different trace width from neighboring layers to provide a different propagation delay for traces on each layer.

18. The computer-readable storage medium of claim 16, wherein traces within the layer are oriented perpendicular to traces in adjacent layers.

19. The computer-readable storage medium of claim 16, wherein grouping traces within each layer involves establishing a grouping pattern for each layer that allows alternate layers to be aligned so that the shield trace on the nearby layer is substantially centered on the group of traces within the layer.

20. The computer-readable storage medium of claim 16, wherein the shield trace is a power trace or a ground trace.
